(19) United States
(12) Patent Application Publication
(10) Pub. No.: US 2023/0034118 A1
(43) Pub. Date: Feb. 2, 2023

(54) ELECTRONIC DEVICE COVERS WITH COMPOSITE MATERIAL

(71) Applicant: Hewlett-Packard Development Company, L.P., Spring, TX (US)

(72) Inventors: Stacy L. Wolff, Spring, TX (US); Eric Wright Chen, Spring, TX (US); Ilchan Lee, Spring, TX (US); Chad Patrick Paris, Spring, TX (US); Woojin Chung, Spring, TX (US)

(73) Assignee: Hewlett-Packard Development Company, L.P., Spring, TX (US)

(21) Appl. No.: 17/790,815

(22) PCT Filed: Feb. 4, 2020
(86) PCT No.: PCT/US2020/016585

§ 371 Date: Jul. 5, 2022

(51) Int. Cl. G06F 1/16

(52) U.S. Cl. CPC G06F 1/1656; G06F 1/1616; G06F 1/1662; G06F 1/1637

(57) ABSTRACT

An example electronic device includes a first housing having a first cover and a second cover, where the first cover is made from fibre composite material, where the second cover is made from metal, and where the first cover is bonded to the second cover via adhesive. The electronic device also includes a display device disposed in the first housing.

### BACKGROUND

Portable electronic devices, such as laptop computers, have become popular due to their relative light-weight as compared to desktop computers. Device manufacturers continue to change aspects of portable electronic devices to further increase their portability.

### BRIEF DESCRIPTION OF THE DRAWINGS

Some examples of the present application are described with respect to the following figures:

FIG. 1 is an exploded view of an electronic device having fiber composite material and metal in a housing of the electronic device, according to an example;

FIG. 2 is an exploded view of an electronic device having fiber composite material and metal in a housing of the electronic device, according to another example;

FIG. 3 is an exploded view of an electronic device having fiber composite material and metal in housings of the electronic device, according to an example; and

FIG. 4 illustrates a process to manufacture a housing of an electronic device where the housing is made from fiber composite material and metal, according to an example.

### DETAILED DESCRIPTION

Housings of an electronic device, such as a laptop computer, a tablet computer, a mobile phone, etc. may be made with plastic to save weight. However, plastic housings may be lack structural rigidity. Thus, when a plastic housing is rotated, the plastic housing may wobble due to the low structural rigidity. The user experience may be negatively impacted as a user of the electronic device may perceive the electronic device to be of low quality.

Examples described herein provide an approach to manufacture a housing of an electronic device that is light-weight while having greater structural rigidity as compared to plastic. In an example, an electronic device may include a first housing having a first cover and a second cover. The first cover may be made from fiber composite material. The second cover may be made from metal. The first cover may be bonded to the second cover via adhesive. The electronic device may further include a display device disposed in the first housing.

In another example, an electronic device may include a first housing having a first cover and a second cover. The electronic device may also include a display device disposed in the first housing. The electronic device may further include a second housing having a third cover and a fourth cover. The third cover may be made from fiber composite material. The fourth cover may be made from metal. The third cover may be bonded to the fourth cover via adhesive. The electronic device may further include an input device disposed in the second housing.

In another example, an electronic device may include a first housing having a first cover and a second cover. The first cover may be made from fiber composite material. The second cover may be made from metal. The first cover may be bonded to the second cover via adhesive. The electronic device may also include a display device disposed in the first housing, a second cover, a display device disposed in the first housing, and a second housing having a third cover and a fourth cover. The third cover may be made from the fiber composite material. The fourth cover may be made from the metal. The third cover may be bonded to the fourth cover via the adhesive. The electronic device may further include a keyboard and a click pad device disposed in the second housing. Examples described herein may enable an electronic device to have light-weight yet structurally rigid housings.

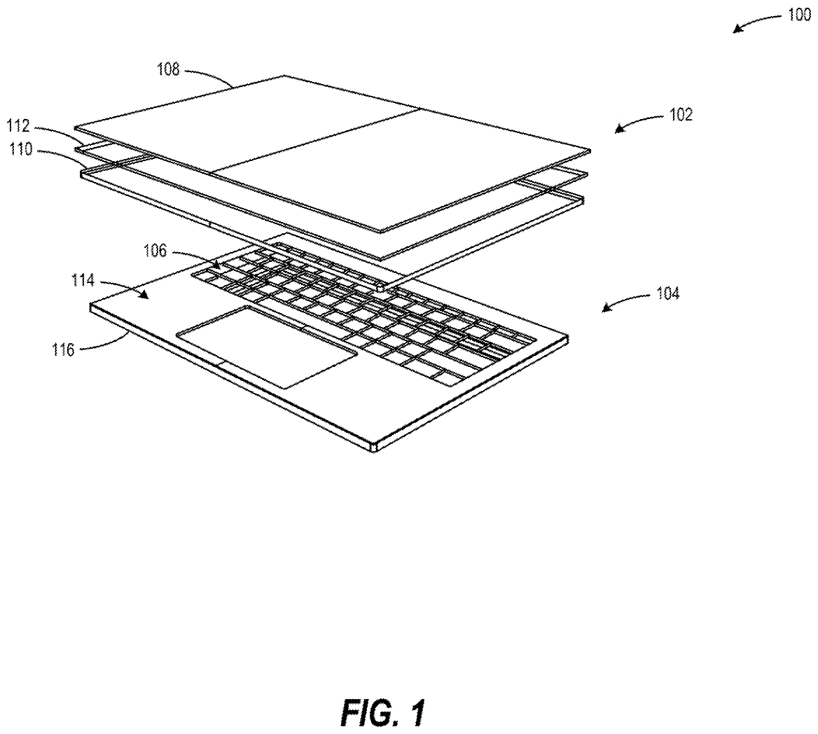

FIG. 1 is an exploded view of an electronic device 100 having fiber composite material and metal in a housing of the electronic device, according to an example. Electronic device 100 may be a laptop computer. Electronic device 100 may include a first housing 102 and a second housing 104. Components of electronic device 100, such as a display device, a processor, memory, etc. may be disposed in housings 102 and 104. For example, a display device (not shown in FIG. 1) may be disposed in first housing 102. The display device may be implemented using a display panel (e.g., liquid crystal display panel) and a controller. An input device 106 may be disposed in second housing 104, In some examples, input device 106 may be a keyboard, a touchpad, or a combination thereof. In some examples, input device 106 may be a touch-sensitive display device. As described in more detail below, first housing 102 may be made from dissimilar material while second housing 104 may be made from the same material.

First housing 102 may include a first cover 108 and a second cover 110. First cover 108 may be made from fiber composite material. In some examples, fiber composite material may include carbon fiber, such as carbon fiber made from a compression molding process, woven carbon fiber, etc. In some examples, fiber composite material may include glass fiber.

Second cover 110 may be made from metal. In some examples, metal may include aluminum. In some examples, metal may include aluminum alloy. In some examples, metal may include magnesium. In some examples, metal may include magnesium alloy.

To bond first cover 108 to second cover 110, adhesive may be used. A ring of adhesive 112 may be applied to a gap defined by first cover 108 and second cover 110. The gap may be defined by a difference between respective diameters of first cover 108 and second cover 110. In some examples, a diameter of first cover 108 may be smaller a diameter of second cover 110. Thus, when coupled together, the difference in diameters may define the gap. Ring of adhesive 112 may be applied via an injection molding process. In some examples, adhesive may be implemented using epoxy adhesive. In some examples, adhesive may be implemented using resin adhesive.

Second housing 104 may include a third cover 114 and a fourth cover 116. Third cover 114 and fourth cover 116 may be made from the same material, such as metal.

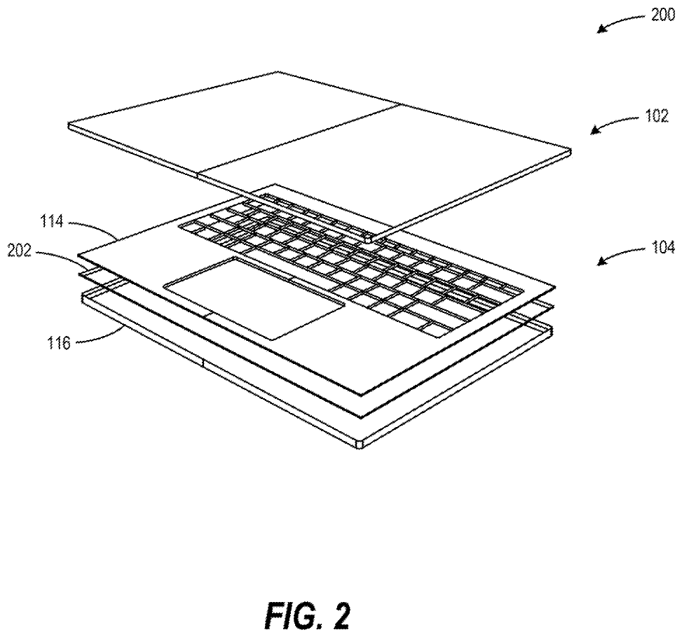

FIG. 2 is an exploded view of an electronic device 200 having fiber composite material and metal in a housing of electronic device 200, according to another example. Electronic device 200 may include first housing 102 and second housing 104. First housing 102 may be made from the same material, such as metal, while second housing 104 may be made from dissimilar material. Third cover 114 of second housing 104 may be made from fiber composite material and fourth cover 116 of second housing 104 may be made from metal. A ring of adhesive 202 may be applied to a gap defined by third cover 114 and fourth cover 116. The gap may be defined by a difference between respective diameters of third cover 114 and fourth cover 116. In some examples, a diameter of third cover 114 may be smaller a diameter of fourth cover 116. Thus, when coupled together, the difference in diameters may define the gap.

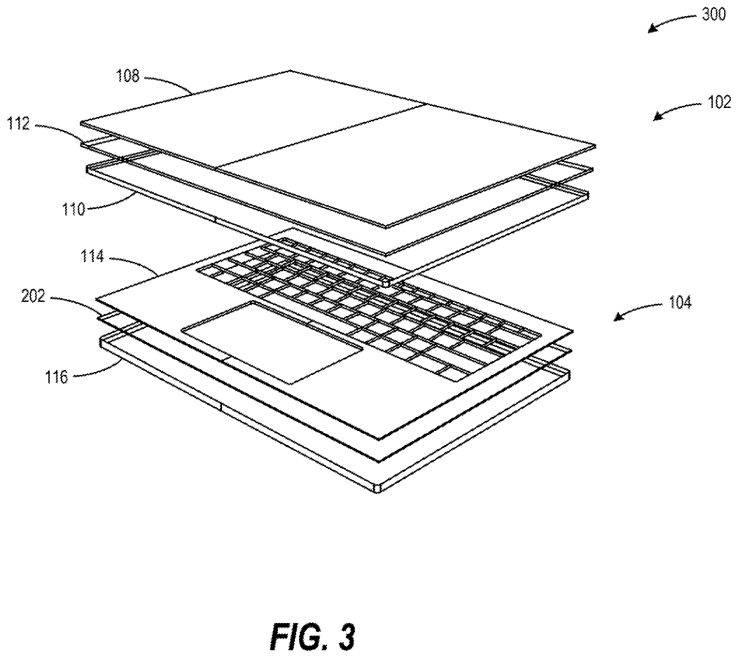

FIG. 3 is an exploded view of an electronic device 300 having fiber composite material and metal in housings of the electronic device, according to an example. Electronic device 300 may include first housing 102 and second housing 104. First housing 102 and second housing 104 may each be made from dissimilar material. First cover 108 of first housing 102 and third cover 114 of second housing 104 may be made from fiber composite material. Second cover 110 of first housing 102 and fourth cover 116 of second housing 104 may be made from metal. Rings of adhesive 112 and 202 may be used to bond respective covers 108 and 114 to 110 and 116, respectively.

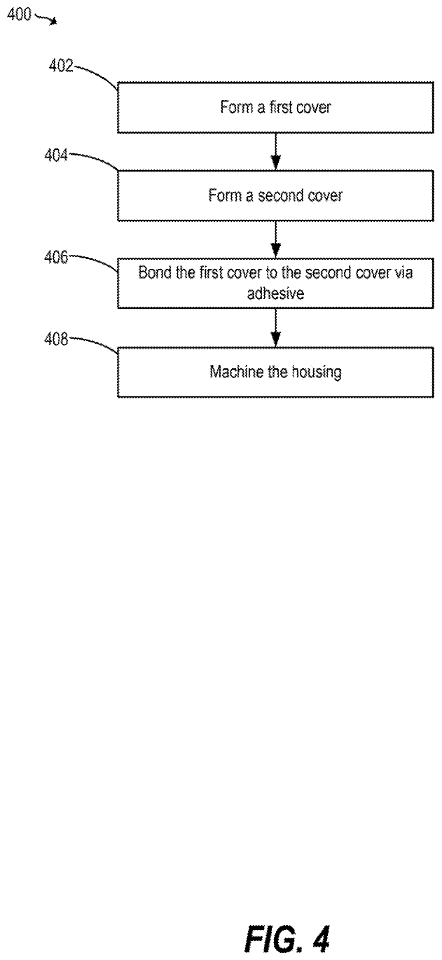

FIG. 4 illustrates a process 400 to manufacture a housing of an electronic device where the housing is made from fiber composite material and metal, according to an example. Process 400 may be used to form first housing 102, second housing 104, or a combination thereof. Process 400 may include forming a cover of a housing, at 402. For example, first cover 108 may be formed using fiber composite material. Far example, first cover 108 may be formed as a carbon fiber sheet. Process 400 may also include forming another cover of the housing, at 404. For example, second cover 110 may be formed using metal via a stamping process.

Process 400 may further include bonding the two covers together via adhesive, at 406. For example, ring of adhesive 112 may be injected to a gap between first cover 108 and second cover 110 via an injection molding process. Process 400 may further include painting the housing, at 408. For example, first housing 102 may be painted once first housing 102 is assembled. First cover 108 and second cover 110 may be painted to different colors. Process 400 may further include machining the housing, at 408. For example, edges of second cover 110 may be machined to form a particular shape (e.g., rounded corners).

The use of “comprising”, “including” or “having” are synonymous and variations thereof herein are meant to be inclusive or open-ended and do not exclude additional unrecited elements or method steps.

What is claimed is:

1. An electronic device comprising:
a first housing having a first cover and a second cover, wherein the first cover is made from fibre composite material, wherein the second cover is made from metal, and wherein the first cover is bonded to the second cover via adhesive; and
a display device disposed in the first housing.

2. The electronic device of claim 1, wherein the fibre composite material includes carbon fibre and glass fibre.

3. The electronic device of claim 1, wherein the metal includes aluminium, aluminium alloy, magnesium, and magnesium alloy.

4. The electronic device of claim 1, wherein the adhesive is disposed in a gap defined by the first cover and the second cover.

5. The electronic device of claim 1, further comprising:
a second housing;
an input device disposed in the second housing; and
a hinge to attach the first housing to the second housing.

6. An electronic device comprising:
a first housing having a first cover and a second cover;
a display device disposed in the first housing;
a second housing having a third cover and a fourth cover, wherein the third cover is made from fibre composite material, wherein the fourth cover is made from metal, and wherein the third cover is bonded to the fourth cover via adhesive; and
an input device disposed in the second housing.

7. The electronic device of claim 6, wherein the input device is a keyboard.

8. The electronic device of claim 6, wherein the input device is a touch-sensitive display device.

9. The electronic device of claim 6, wherein the adhesive includes polyurethane reactive adhesive.

10. The electronic device of claim 6, wherein the fibre composite material includes compressed carbon fibre.

11. An electronic device comprising:
a first housing having a first cover and a second cover wherein the first cover is made from fibre composite material, wherein the second cover is made from metal, and wherein the first cover is bonded to the second cover via adhesive;
a display device disposed in the first housing;
a second cover;
a display device disposed in the first housing;
a second housing having a third cover and a fourth cover, wherein the third cover is made from the fibre composite material, wherein the fourth cover is made from the metal, and wherein the third cover is bonded to the fourth cover via the adhesive; and
a keyboard and a click pad device disposed in the second housing.

12. The electronic device of claim 11, wherein the fibre composite material includes glass fibre.

13. The electronic device of claim 11, wherein the first cover has a smaller diameter than the second cover.

14. The electronic device of claim 11, wherein the electronic device is a clamshell style laptop computer.

15. The electronic device of claim 11, wherein the electronic device is a convertible style laptop computer.
